(19) United States
(12) Patent Application Publication
(10) Pub. No.: US 2026/0264932 A1
(43) Pub. Date: Sep. 10, 2026

(54) STACKABLE STORAGE SYSTEM

(71) Applicant: Techtronic Cordless GP, Anderson, SC (US)

(72) Inventors: Kyle Yeomans, Easley, SC (US); Sage Van Wyk, Greenville, SC (US); Anthony Tocco, Easley, SC (US); Keith Lombardi, Easley, SC (US); John D. Parsons, Greenville, SC (US)

(21) Appl. No.: 19/549,838

(22) Filed: Feb. 25, 2026

Related U.S. Application Data
(60) Provisional application No. 63/767,832, filed on Mar. 6, 2025.

(51) Int. Cl. B65D 21/02; B65D 43/16

(52) U.S. Cl. CPC B65D 21/0223; B65D 43/163

(57) ABSTRACT

A storage container, a stackable storage system, and a mating interface are provided. A storage container includes a base and a lid. The container includes a plurality of pockets positioned on one of the base and the lid and having sides recessed with respect to a first direction, each of the pockets having a polygonal profile surrounding an open space; and a surface formed on the other of the base and the lid, having a plurality of projections extending from the surface, each of the projections having a projection profile substantially corresponding to an associated one of the pockets. An edge portion protrudes from one of the projections, and a gap is formed between the edge portion and the surface. The container includes a sliding member having a blocking surface extending generally parallel to the front surface of the base, the sliding member having a locked position and an unlocked position.

### CROSS-REFERENCE TO RELATED APPLICATIONS

The present application claims priority to U.S. Provisional Patent Application No. 63/767,832, filed on Mar. 6, 2025, the disclosure of which is incorporated by reference herein in its entirety.

### FIELD

The present disclosure relates to storage containers and, more particularly, to storage containers that are securable to one another in a stackable configuration.

### BACKGROUND

Hand tools, power tools, and associated accessories such as light sources, batteries, tool bits, fasteners, and the like, may be moved frequently between a storage space and a workspace. One aspect of accessibility is a user's ability to quickly store an object and remove or relocate the object from storage. Another aspect of accessibility is the storage system's ability to engage many objects with a standardized connection mechanism between the system and the object. This may also permit an object to engage the storage system at a plurality of locations. Storage systems may also be accessible for extension or expansion.

However, existing storage systems for organization of tools and accessories for transit to a job site leave much to be desired. For instance, open volume and bag storage systems commonly used for transit can be chaotic and disorganized without intentional storage zones to hold each item in place. After transit to a “job site,” the tools and accessory organization may be expanded back out to create a usable work space. However, due to poor or non-existent organizational solutions during transit, organization at a job site may be difficult as well. Moreover, mobile organizational solutions for setting up a job site in a functional and usable work space may be insufficient to both provide easy functional access to tools and accessories while maintaining cost-effectiveness and durability. For example, existing organization solutions such as stacking containers may have complicated locking features that have more components, thereby increasing potential for parts or pieces to break, and are more costly to manufacture, thereby driving up the price for consumers.

Accordingly, improved stacking storage systems are desired in the art. In particular, stacking storage systems which provide improved stacking and locking features would be advantageous.

### BRIEF DESCRIPTION

Aspects and advantages of the present disclosure will be set forth in part in the following description, or may be obvious from the description, or may be learned through practice of the technology.

In accordance with one embodiment, a storage container is provided. The storage container includes: a base, and a lid pivotably coupled to the base by a hinge and selectively retained in a closed position. The container includes a plurality of pockets positioned on one of the base and the lid and having sides recessed with respect to a first direction, each of the pockets defining an open space surrounded at least partially by a wall extending from the base or the lid, at least one angled edge of each wall being oriented at an oblique angle relative to a front surface of the base. The container further includes a surface formed on the other of the base and the lid, and a plurality of projections extending from the surface with respect to the first direction, each of the projections having a projection profile substantially corresponding to an associated one of the pockets, each of the projections being substantially aligned with the associated one of the pockets along the first direction. The container further includes an edge portion protruding from one of the projections in a plane substantially normal with respect to the first direction, the edge portion oriented at the oblique angle relative to a front surface of the base′ and a gap formed between the edge portion and the surface. The container further includes a sliding member having a blocking surface extending generally parallel to the front surface of the base, the sliding member having a locked position and an unlocked position.

In accordance with another embodiment, a stackable storage system is provided. The stackable storage system includes a first container and a second container. The first container includes a projection extending away from the first container along a stacking direction, and an edge portion extending from the projection along a plane substantially perpendicular to the stacking direction. The second container includes a recess extending in a direction parallel to the stacking direction, the recess receives the projection when the first container and the second container are stacked relative to one another in the stacking direction, and the recess further includes at least one wing configured to retain the edge portion of the projection. The system further includes a sliding member moveable between a first position and a second position, the sliding member configured to abut a surface of the projection while the sliding member is in the first position to secure the first container and the second container to one another, the sliding member and the projection are positioned in a non-contacting manner relative to one another while the sliding member is in the second position to permit separation of the first container from the second container.

In accordance with another embodiment, a mating interface for selectively securing a first container relative to a second container in a stacked configuration along a stacking direction is provided. The mating interface includes a projection positioned on one of the first container and the second container, the projection being spaced apart from a surface to form a gap, the gap being open in a direction transverse to the stacking direction; and a sliding member moveably mounted to the other of the first container and the second container, the sliding member moveable in the direction transverse to the stacking direction between a first position and a second position. In the first position, a portion of the sliding member is positioned against a side surface of the projection thereby preventing relative movement between the first container and the second container along a direction generally perpendicular to the stacking direction and the direction transverse to the stacking direction. In the second position, the sliding member is not positioned against the projection, enabling relative movement between the first container and the second container along a direction generally perpendicular to the stacking direction and the direction transverse to the stacking direction

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a stackable storage system in accordance with embodiments of the present disclosure;

FIG. 2 is a top perspective view of a stackable storage container in accordance with embodiments of the present disclosure;

FIG. 3 is a bottom perspective view of a stackable storage container in accordance with embodiments of the present disclosure;

FIG. 4 is a front view of a locking member of a stackable storage container in accordance with embodiments of the present disclosure;

FIGS. 5A and 5B are bottom views of a stackable storage container in accordance with embodiments of the present disclosure with the locking member in an unlocked position and a locked position, respectively;

FIGS. 6A and 6B are cross-sectional views of a stackable storage system in accordance with embodiments of the present disclosure in an unlocked stacked arrangement and a locked stacked arrangement, respectively; and

FIG. 7 is a schematic of a method for stacking containers in a stackable storage system in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a stackable storage system including a stackable container and a mating interface for stacking and securing storage components together. A storage container includes pockets on a lower surface thereof having a corresponding shape to projections of a complementary stackable storage component. The projections include gaps and the pockets include wings engageable within the gaps. The storage container further includes a locking member slidable between and unlocked position and a locked position having a blocking member to engage a surface of the projections. The present inventors have found that the stackable storage system of the present invention enables locking two or more stacked storage components together with a simplified stacking and locking arrangement.

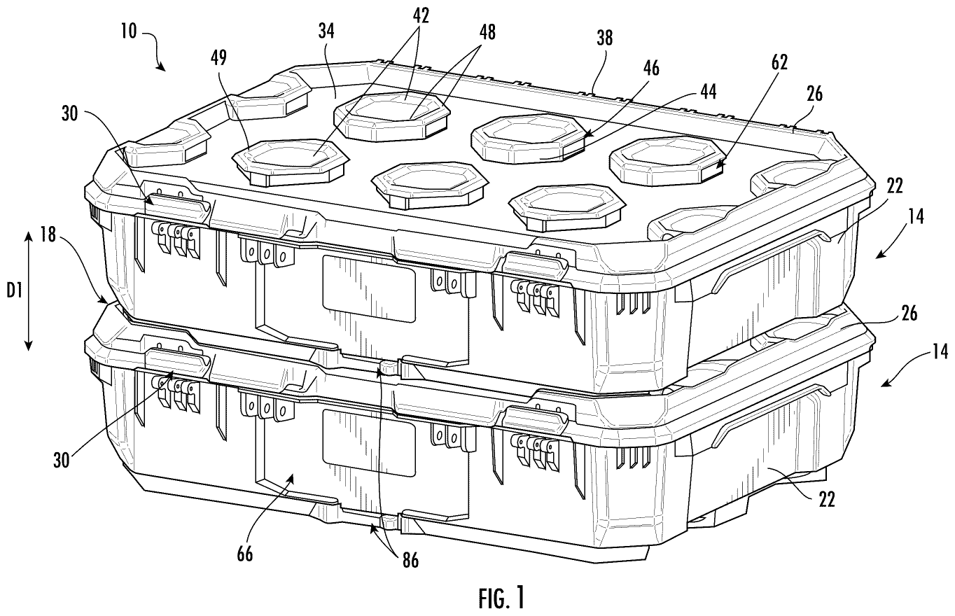

Referring now to the drawings, FIG. 1 illustrates a system 10 of multiple storage components or elements 14 (e.g., containers, toolboxes, and/or the like) in a stacked configuration and secured relative to one another along a stacked or stacking direction D1. The system 10 includes an interface 18 for mating opposite and optionally complementary surfaces of the storage containers 14 relative to one another. Each storage container 14 may include a base 22 and a lid 26 coupled to the base 22, e.g., rotatably coupled by a hinge 30. In the illustrated embodiment, an upper surface of the lid 26 includes a surface 34 at least partially surrounded by a peripheral lip 38. In the illustrated embodiment, the lip 38 extends upwardly from the surface 34, and in some embodiments the surface 34 may be depressed. In the illustrated embodiment, the lip 38 extends upwardly from the surface 34 and limits relative sliding and/or rotation between containers 14 when stacked. As persons having skill in the art will appreciate, containers having non-hinged and/or non-rotatable lids (e.g., translating lids) are contemplated herein. Some embodiments may include, for example, removable lids (e.g., lids having latches without pivoting and/or hinges) and/or drawers that slide relative to another structure or stationary cover, and/or the like.

The lid 26 includes a plurality of projections 42 that extend from the surface 34 in the stacking direction D1. Each of the projections 42 may include a base 44 and an overhanging portion or tab 46 supported on the projection 42. The projections 42 may include rectangular or non-rectangular shapes, and symmetric or asymmetric shapes. Much of the tab 46 extends outwardly from the projection 42 in a direction parallel to the surface 34 and is spaced apart from the surface 34 in the stacking direction D1, forming a space or gap 62 between the tab 46 and the surface 434 having a depth along the stacking direction D1. In the illustrated embodiment, the projections 42 extend from the surface 34 adjacent one another such that a portion of the tab 46 extends outwardly toward an adjacent projection 42. The projections 42 may be arranged next to one another. For instance, the projections 42 may be arranged in an array on the surface 34. Some of the projections 42 and/or tabs 46 may be contiguous with the peripheral lip 38.

In the illustrated embodiment, the base 44 of each projection 42 has an octagonal-shaped profile, and a tab 46 extends from an oblique side 48 of the base 44 that is oriented at an oblique angle relative to a front surface 66 of the container 14, and the gap 62 therefore is oriented along an oblique angle. In the illustrated embodiment, a straight portion or tooth 49 is positioned between oblique side 48, and the overall projection 42 may have an octagonal-shaped profile. In some embodiments, the base and/or the projection may include only the oblique sides 48, thereby having a rhomboid (e.g., diamond) shaped profile. In still other embodiments, the base and/or projection may have a different shape.

In the illustrated embodiment, the container 14 includes a plurality of projections 42 in a grid pattern including two rows of three projections each, as well as two “half” projections formed integrally with the lip 38. In other embodiments, the container 14 may include fewer or more rows and/or fewer or more projections in each row. In still other embodiments, the lid may be omitted from the container 14, and the base may be formed to include a lip including one or more projections 42 such that the base can still be stacked and secured to another storage container 14.

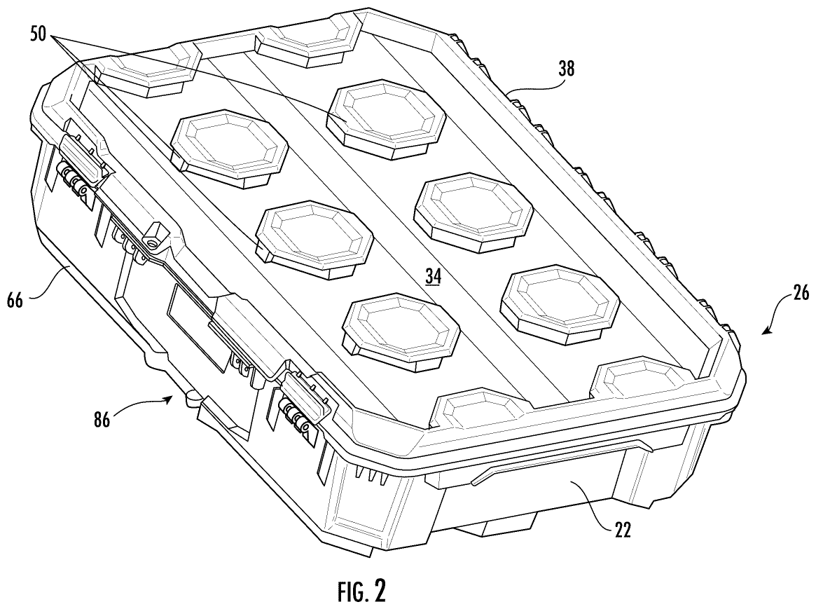

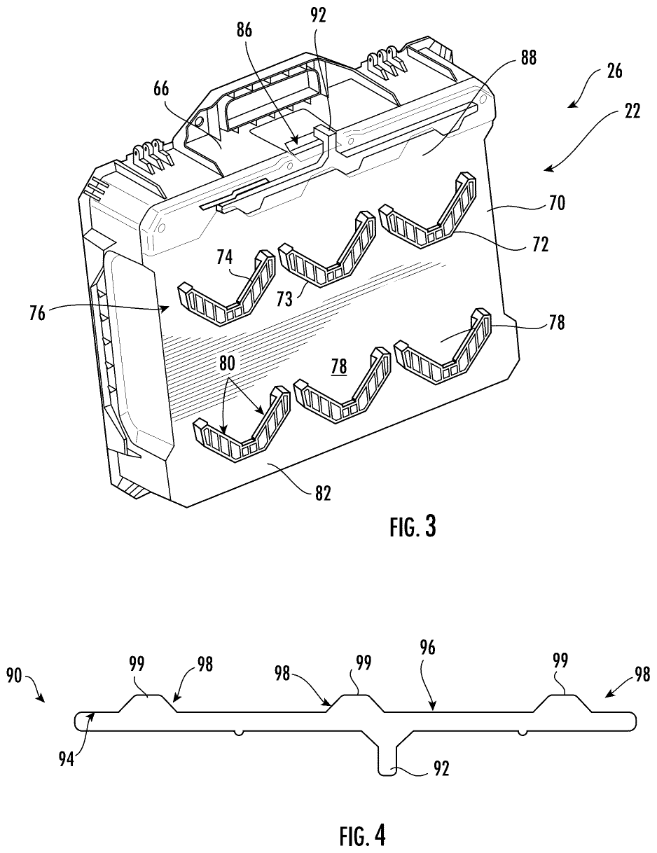

As illustrated in FIGS. 1-3, the base 22 includes a front surface 66, a lower surface 70, a plurality of mating features 72 offset from the lower surface 70, recesses or pockets 78 that correspond to the projections 42, and a locking assembly 86. In the illustrated embodiment, the lower surface 70, mating features 72, pockets 78, and locking assembly 86 may be formed as a part of the base 22, or one or more components may alternatively be formed separately from the base 22. For instance, the mating features 72 may each include a protrusion having an outer wall 73 and an inner wall 74 each extending away from the lower surface 70. At least a portion of each outer wall 73 and inner wall 74 may be parallel to each other.

Each pocket 78 is defined by a respective one of the mating features 72 and is configured to receive an associated one of the projections 42. For instance, each pocket 78 is defined by the inner wall 74 of one of the mating features 72. The inner wall 74 may have a complementary shape to at least a portion of one of the projections 42. For instance, the inner wall 74 may be generally three-sided in similar proportions to a bottom portion of one of the octagonal-shaped projections 42. In addition to the projections 42 and the mating features 72, the mating interface 18 between the storage containers may include engagement between other complementary features, such as the lip 38 or the lower surface 70. In the illustrated embodiment, the mating features 72 provide a first coupling portion and the projections 42 provide a second coupling portion.

Each mating feature 72 further includes one or more undercuts 80 extending inward toward an open space within the pocket 78 beneath the inner wall 74. For instance, the one or more undercuts 80 may extend from one or more of the oblique sides of the inner wall 74 (corresponding to a respective oblique side 48 of a corresponding projection 42). Each undercut 80 may have a depth so as to be able to fit within the gap 62 between the tab 46 of a projection and the surface 34 of the lid 26. In the illustrated embodiment, each inner wall 74 may include two undercuts 80, with each undercut 80 arranged on opposite sides of a rear side 82 of the mating feature 72 disposed opposite of a front surface 50 of the projection 42.

When a first and second containers 14 are aligned and stacked relative to one another, the surface 34 is oriented in a facing relationship with the lower surface 70. In the illustrated embodiment, adjacent storage containers 14 are stackable at the mating interface 18, and the pockets 78 of one storage container 14 (e.g., an upper container) receive the projections 42 of another storage container 14 (e.g., the lower container). Stated another way, the first coupling portion may be positioned around the second coupling portion at the mating interface 18.

The various complementary surfaces of the lid 26 and the base 22 are configured to limit sliding and/or rotation between toolboxes 14 when stacked. The various complementary surfaces also advantageously prevent the lid 26 and base 22 or opposing stacked containers 14 from shifting relative to one another in the direction parallel to the surface 34. In this way, the containers 14 are more stable when stacked and are less likely to become unstacked during use and/or transportation. Stated another way, relative movement in a direction normal to the stacking direction D1 between containers 14 is prohibited, prevented, or otherwise minimized while the containers 14 are stacked along the stacking direction D1.

Referring now to FIGS. 4A and 4B, the locking assembly 86 includes a locking member 90 (e.g., a plate, tab, arm, and/or the like) and an actuator 92, e.g., a handle. The actuator 92 is movable by a user to move the locking member 90 relative to the base 22 in a direction along axis F, which may be parallel to the surface 34, in one embodiment by way of example. The locking member 90 may be supported in the base 22. The locking assembly 86 is supported such that when the base 22 of one container 14 is stacked on the lid 26 of the other container 14, the locking member 90 is oriented in a plane parallel to a lower surface of the base 22, and the locking member 90 is selectively movable to be positioned away from the projections 42 or abutting against the projections 42, e.g., against a front surface 50 of at least one of the projections 42.

Described now in further detail, the locking member 90 includes a body 94 having a first side 96 arranged to face the pockets 78 of the base 22. The first side 96 includes at least one blocking structure 98 extending therefrom. Each blocking structure 98 is configured to align with a front surface 50 of a projection 42 when the containers 14 are stacked and the locking member 90 is in the locked position. In particular, the blocking structure 98 includes a blocking surface 99 configured to be generally parallel to the front surface 50 of the projection 42. In the illustrated embodiment, each blocking structure 98 may have a generally polygonal shape, such as but not limited to a trapezoidal shape, a rectangular shape, or any other suitable shape.

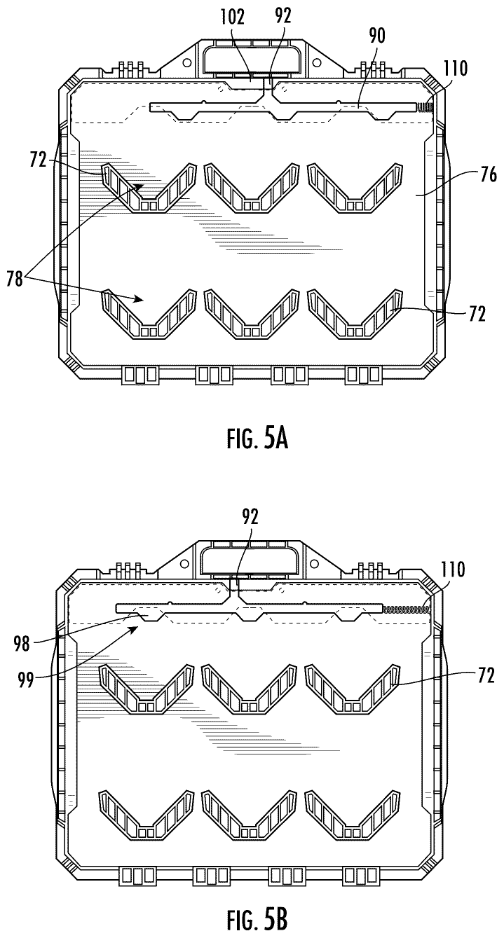

The base 22 may further include a locking assembly cover plate 88. The locking assembly cover plate 88 may house the locking member 90 therein. The locking assembly cover plate 88 may form at least a portion of one or more of the pockets 78 forming a first row 76 of pockets 78. As best seen in FIG. 5B, the locking member 90 may be exposed within the pockets 78 in the first row 76 when the locking member 90 is arranged in the locking position. An opening 102 may be formed between the base 22 and the locking assembly cover plate 88 along the front surface 66 of the base 22. The actuator 92 of the locking member 90 may extend through the opening 102. In the illustrated embodiment, the opening 102 is a generally linear opening and enables the actuator 92 to be moved back and forth from one side of the opening to the other side of the opening in a linear direction. The linear direction may be generally parallel to the surface 34 of the lid 26.

In some aspects of the invention, a spring 110, e.g., a coil spring, may be disposed adjacent an end of the locking member 90. The spring 110 may bias the locking member 90 to a specific position. For instance, the spring 110 may bias the locking member 90 in the locking position. In this manner, the spring 110 may be in a generally relaxed state when the locking member 90 is in the locking position, and the spring 110 may be compressed when the locking member 90 is moved into the unlocked position, e.g., by movement of the actuator 92. When the actuator 92 is released by a user, or otherwise a force on the actuator 92 is released, the spring 110 may urge the locking member 90 back into the locking position.

FIG. 5A illustrates a bottom view of the container 14 with the locking assembly 86 in the unlocked position, also referred to herein as the “second” position. In the unlocked position, the blocking structures 98 of the locking member 90 are not exposed within the pockets 78. Instead, the blocking structures 98 are enclosed between the base 22 and the locking assembly cover plate 88.

FIG. 5B illustrates a bottom view of the container 14 with the locking assembly 86 in the locked position, also referred to herein as the “first” position. In the locked position, the blocking structures 98 of the locking member 90 are exposed within the pockets 78 of the 76. The blocking surfaces 99 extend generally parallel to the front surface 66 of the base 22. When the container 14 illustrated in FIG. 5B is stacked on top of another container, e.g., as illustrated in FIG. 1, the blocking surfaces 99 face the front surfaces 50 of the projections 42 of the bottom container. Moreover, the pockets 78 in the row 76 are sized such that the projections 42 must be slid in a backward direction away from the locking member 90 so that the undercuts 80 and the inner walls 74 of the respective mating features 72 are engaged within the gaps 62 in order for the blocking surfaces 99 to be parallel to the front surfaces 50 of the projections 42. In this manner, the containers 14 are prevented from shifting relative to each other. Specifically, the engagement of the locking assembly 86 prevents forward/backward movements, while the engagement of the undercuts 80 of the pockets 78 and the inner walls 74 with the gaps 62 between the projections 42 and the surface 34 prevents lateral side to side and vertical movements between the containers 14.

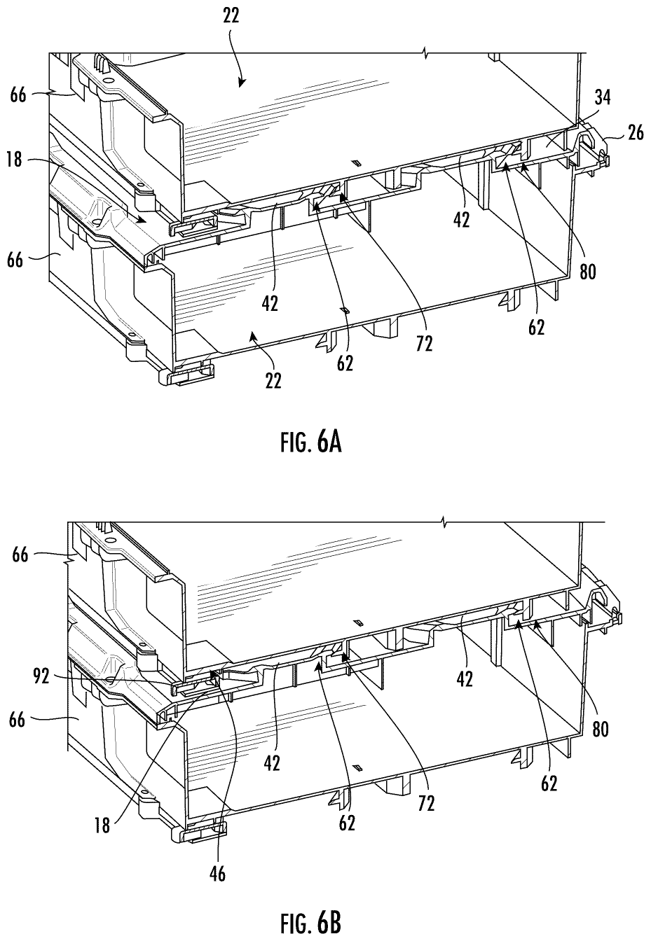

FIG. 6A illustrates a cross-sectional view of two containers 14 stacked such that the projections 42 of the bottom container are within the pockets 78 of the top container without engagement of the undercuts 80 or inner walls 74 of the mating features 72 in the gaps 62. The front surface 66 of the bottom container and the front surface 66 of the top container extend generally parallel to each other but are not generally coplanar.

FIG. 6B illustrates a cross-sectional view of two containers 14 stacked and locked together. Relative to the arrangement illustrated in FIG. 6A, the top container has been pulled forward to engage the undercuts 80 of the inner walls 74 of the respective mating features 72 of the top container within the gaps 62 between the projections 42 and the lid surface 34 of the bottom container. The front surface 66 of the bottom container and the front surface 66 of the top container are generally coplanar. The locking assembly 86 is moved into the first position with the actuator 92 slid to the side and the blocking surface 99 parallel to the front surface 50 of the projections 42.

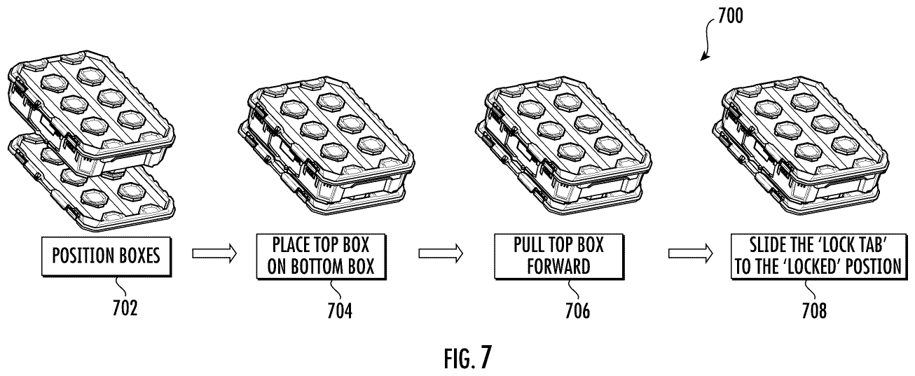

FIG. 7 illustrates a method 700 of securely stacking and locking stacked containers together. In step 702, a bottom container 14 and a top container 14 are positioned relative to each other. In particular, the containers are positioned so that the projections 42 of the bottom container and the pockets 78 of the top container align. In step 704, the top container is placed onto the lid 26 of the bottom container so that the projections 42 of the bottom container are disposed within the pockets 78 of the top container. In this arrangement, the front surfaces 66 of the containers are generally parallel but not coplanar. In step 706, the top box is pulled forward (i.e., in the direction towards the locking assembly 86 and its exposed actuator 92) relative to the bottom container. In the arrangement following step 706, the front surfaces 66 of the bases 22 of each container are generally coplanar. Finally, in step 708, the locking assembly 86 is engaged by sliding the actuator 92 of the locking member 90 to the “first” or locked position, thereby locking the respective projections and pockets in place.

Further aspects of the disclosure are provided by one or more of the following embodiments:

A storage container includes: a base, and a lid pivotably coupled to the base by a hinge and selectively retained in a closed position. The container includes a plurality of pockets positioned on one of the base and the lid and having sides recessed with respect to a first direction, each of the pockets defining an open space surrounded at least partially by a wall extending from the base or the lid, at least one angled edge of each wall being oriented at an oblique angle relative to a front surface of the base. The container further includes a surface formed on the other of the base and the lid, and a plurality of projections extending from the surface with respect to the first direction, each of the projections having a projection profile substantially corresponding to an associated one of the pockets, each of the projections being substantially aligned with the associated one of the pockets along the first direction. The container further includes an edge portion protruding from one of the projections in a plane substantially normal with respect to the first direction, the edge portion oriented at the oblique angle relative to a front surface of the base′ and a gap formed between the edge portion and the surface. The container further includes a sliding member having a blocking surface extending generally parallel to the front surface of the base, the sliding member having a locked position and an unlocked position.

The storage container of any one or more of the embodiments, wherein the gap is formed along a side of each projection at a non-zero angle relative to the front surface of the base.

The storage container of any one or more of the embodiments, wherein the sliding member is configured to abut a front surface of at least one of the projections.

The storage container of any one or more of the embodiments, wherein the front surface of each projection extends generally parallel to the front surface of the base.

The storage container of any one or more of the embodiments, wherein the front surface abutted by the sliding member does not include the gap.

The storage container of any one or more of the embodiments, wherein the wall each of the plurality of pockets comprises an undercut extending inward from the at least one angled edge towards an open space of each respective pocket.

The storage container of any one or more of the embodiments, wherein the at least one angled edge of the wall of each pocket comprises at least two angled edges, further wherein each of the at least two angled edges is oriented at an oblique angle relative to a front surface of the base.

The storage container of any one or more of the embodiments, wherein each of the plurality of pockets includes a first wing extending inward from a first one of the at least two angled edges towards the open space of each respective pocket and a second wing extending inward from a second one of the at least two angled edges towards the open space of the respective pocket.

The storage container of any one or more of the embodiments, wherein the at least two angled edges are not adjacent to each other.

The storage container of any one or more of the embodiments, wherein the sliding member comprises a side profile generally matching a portion of the polygonal profile of each of the pockets, wherein the blocking surface forms a portion of the side profile of the sliding member.

A stackable storage system includes a first container and a second container. The first container includes a projection extending away from the first container along a stacking direction, and an edge portion extending from the projection along a plane substantially perpendicular to the stacking direction. The second container includes a recess extending in a direction parallel to the stacking direction, the recess receives the projection when the first container and the second container are stacked relative to one another in the stacking direction, and the recess further includes at least one wing configured to retain the edge portion of the projection. The system further includes a sliding member moveable between a first position and a second position, the sliding member configured to abut a surface of the projection while the sliding member is in the first position to secure the first container and the second container to one another, the sliding member and the projection are positioned in a non-contacting manner relative to one another while the sliding member is in the second position to permit separation of the first container from the second container.

The stackable storage system of any one or more of the embodiments, wherein when the sliding member is in the first position, the sliding member and the recess together form a pocket having a polygonal profile matching a polygonal profile of the projection.

The stackable storage system of any one or more of the embodiments, wherein when the sliding member is in the second position, the projection may move within the recess in a direction perpendicular to the stacking direction.

A mating interface for selectively securing a first container relative to a second container in a stacked configuration along a stacking direction includes a projection positioned on one of the first container and the second container, the projection being spaced apart from a surface to form a gap, the gap being open in a direction transverse to the stacking direction; and a sliding member moveably mounted to the other of the first container and the second container, the sliding member moveable in the direction transverse to the stacking direction between a first position and a second position. In the first position, a portion of the sliding member is positioned against a side surface of the projection thereby preventing relative movement between the first container and the second container along a direction generally perpendicular to the stacking direction and the direction transverse to the stacking direction. In the second position, the sliding member is not positioned against the projection, enabling relative movement between the first container and the second container along a direction generally perpendicular to the stacking direction and the direction transverse to the stacking direction.

The mating interface of any one or more of the embodiments, wherein the gap of the projection is configured to engage with at least one wing provided on the other of the first container and the second container to prevent relative movement between the first container and the second container in the stacking direction and/or in the direction transverse to the stacking direction.

The mating interface of any one or more of the embodiments, wherein engagement between the gap of the projection and the at least one wing prevents relative movement between the first container and the second container in both the stacking direction and the direction transverse to the stacking direction.

The mating interface of any one or more of the embodiments, wherein the at least one wing comprises two wings, wherein each of the two wings extends on an opposite side of the projection when the wings are engaged with the gap of the projection.

The mating interface of any one or more of the embodiments, wherein the side surface of the projection and the gap are distinct.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A storage container comprising:
a base;
a lid pivotably coupled to the base by a hinge and selectively retained in a closed position;
a plurality of pockets positioned on one of the base and the lid and having sides recessed with respect to a first direction, each of the pockets defining an open space surrounded at least partially by a wall extending from the base or the lid, at least one angled edge of each wall being oriented at an oblique angle relative to a front surface of the base;
a surface formed on the other of the base and the lid;
a plurality of projections extending from the surface with respect to the first direction, each of the projections having a projection profile substantially corresponding to an associated one of the pockets, each of the projections being substantially aligned with the associated one of the pockets along the first direction;
an edge portion protruding from one of the projections in a plane substantially normal with respect to the first direction, the edge portion oriented at the oblique angle relative to a front surface of the base;
a gap formed between the edge portion and the surface; and
a sliding member having a blocking surface extending generally parallel to the front surface of the base, the sliding member having a locked position and an unlocked position.

2. The storage container of claim 1, wherein the gap is formed along a side of each projection at a non-zero angle relative to the front surface of the base.

3. The storage container of claim 1, wherein the sliding member is configured to abut a front surface of at least one of the projections.

4. The storage container of claim 3, wherein the front surface of each projection extends generally parallel to the front surface of the base.

5. The storage container of claim 3, wherein the front surface abutted by the sliding member does not include the gap.

6. The storage container of claim 1, wherein the wall each of the plurality of pockets comprises an undercut extending inward from the at least one angled edge towards an open space of each respective pocket.

7. The storage container of claim 1, wherein the at least one angled edge of the wall of each pocket comprises at least two angled edges, further wherein each of the at least two angled edges is oriented at an oblique angle relative to a front surface of the base.

8. The storage container of claim 7, wherein each of the plurality of pockets includes a first wing extending inward from a first one of the at least two angled edges towards the open space of each respective pocket and a second wing extending inward from a second one of the at least two angled edges towards the open space of the respective pocket.

9. The storage container of claim 7, wherein the at least two angled edges are not adjacent to each other.

10. The storage container of claim 1, wherein the sliding member comprises a side profile generally matching a portion of the polygonal profile of each of the pockets, wherein the blocking surface forms a portion of the side profile of the sliding member.

11. The storage container of claim 1, further comprising a spring configured to bias the sliding member to a locked position.

12. A stackable storage system comprising:
a first container including a projection extending away from the first container along a stacking direction, and an edge portion extending from the projection along a plane substantially perpendicular to the stacking direction;
a second container including a recess extending in a direction parallel to the stacking direction, the recess receives the projection when the first container and the second container are stacked relative to one another in the stacking direction, and the recess further includes at least one wing configured to retain the edge portion of the projection; and
a sliding member moveable between a first position and a second position, the sliding member configured to abut a surface of the projection while the sliding member is in the first position to secure the first container and the second container to one another, the sliding member and the projection are positioned in a non-contacting manner relative to one another while the sliding member is in the second position to permit separation of the first container from the second container.

13. The stackable storage system of claim 12, wherein when the sliding member is in the first position, the sliding member and the recess together form a pocket having a polygonal profile matching a polygonal profile of the projection.

14. The stackable storage system of claim 12, wherein when the sliding member is in the second position, the projection may move within the recess in a direction perpendicular to the stacking direction.

15. The stackable storage system of claim 12, further comprising a spring configured to bias the sliding member in the first position.

16. A mating interface for selectively securing a first container relative to a second container in a stacked configuration along a stacking direction, the mating interface comprising:
a projection positioned on one of the first container and the second container, the projection being spaced apart from a surface to form a gap, the gap being open in a direction transverse to the stacking direction; and
a sliding member moveably mounted to the other of the first container and the second container, the sliding member moveable in the direction transverse to the stacking direction between a first position and a second position,
in the first position, a portion of the sliding member is positioned against a side surface of the projection thereby preventing relative movement between the first container and the second container along a direction generally perpendicular to the stacking direction and the direction transverse to the stacking direction, and
in the second position, the sliding member is not positioned against the projection, enabling relative movement between the first container and the second container along a direction generally perpendicular to the stacking direction and the direction transverse to the stacking direction.

17. The mating interface of claim 16, wherein the gap of the projection is configured to engage with at least one wing provided on the other of the first container and the second container to prevent relative movement between the first container and the second container in the stacking direction and/or in the direction transverse to the stacking direction.

18. The mating interface of claim 17, wherein engagement between the gap of the projection and the at least one wing prevents relative movement between the first container and the second container in both the stacking direction and the direction transverse to the stacking direction.

19. The mating interface of claim 17, wherein the at least one wing comprises two wings, wherein each of the two wings extends on an opposite side of the projection when the wings are engaged with the gap of the projection.

20. The mating interface of claim 16, wherein the side surface of the projection and the gap are distinct.
